(19) United States
(12) Patent Application Publication
(10) Pub. No.: US 2012/0305200 A1
(43) Pub. Date: Dec. 6, 2012

(54) Safe Window Blind

(76) Inventor: Tai-Ping LIU, (US)

(21) Appl. No.: 13/153,387

(22) Filed: Jun. 3, 2011

(51) Int. Cl. E06B 9/68; E06B 9/38; A47H 23/04

(52) U.S. Cl. 160/84.04; 160/319; 160/170

(57) ABSTRACT

A blind device includes a head box, a blind and an operation unit. The head box includes an axle located therein, a roller supported on the axle, and a lift lock located therein. The blind includes a bottom rail and a rope inserted through the lift lock. A first section of the rope is wound on the roller and connected to the bottom rail on a side of the lift lock. A second section of the rope is connected to the head box on another side of the lift lock. The operation unit includes a sleeve connected to the head box, a rod including a first end located in the sleeve and a second end located outside the sleeve, and a pulley connected to the first end of the rod. The second section of the rope is wound on the pulley.

### BACKGROUND OF INVENTION

1. Field of Invention

The present invention relates to a window covering and, more particularly, to a safe window blind.

2. Related Prior Art

There are various window coverings. A window covering is used for keeping sun light and/or noise outside a room, keeping privacy in the room and/or decorating the room. The window coverings can be classified into two types, i.e., curtains that are movable horizontally and blinds that are movable vertically. The blinds include roman blinds, pleated blinds and venetian blinds.

Referring to FIG. 1, a conventional blind device includes a head box 10 and a blind 12 including a bottom rail 13. The blind 12 is a venetian blind as shown. The blind 12 may however be a roman blind or a pleated blind. The blind 12 includes slats. There is an axle 11 located in the head box 10, two rollers 15 provided on the axle 11, and a rope 16 formed with two ends inserted through the slats and connected to the bottom rail 13. The rope 16 further includes a looped section 18 inserted through a lift lock 17 located in the head box 10. The looped section 18 of the rope 16 is pulled down to lift the bottom rail 13 and hence the blind 12. The looped section 18 of the rope 16 is biased to a direction relative to the lift lock 17 so that the former is locked by the latter, i.e., the bottom rail 13 and hence the blind 12 are kept in a lifted position. The looped section 18 of the rope 16 may be biased to an opposite direction relative to the lift lock 17 so that the former is released from the latter, thus allowing the bottom rail 13 and hence the blind 12 to be lowered because of weight.

The looped section 18 of the rope 16 is long and visible by any persons. The looped section 18 of the rope 16 often attracts a kid's attention. The kid cannot help but play with the looped section 18. The kid might get strangled by the looped section 18 of the rope 16, and this is not desirable.

The present invention is therefore intended to obviate or at least alleviate the problems encountered in prior art.

### SUMMARY OF INVENTION

It is the primary objective of the present invention to provide a safe blind.

To achieve the foregoing objective, the blind device includes a head box, a blind and an operation unit. The head box includes an axle located therein, a roller supported on the axle, and a lift lock located therein. The blind includes a bottom rail and a rope inserted through the lift lock. A first section of the rope is connected to the bottom rail on a side of the lift lock. A second section of the rope is connected to the head box on another side of the lift lock. The operation unit includes a sleeve, a rod and a pulley. The sleeve is connected to the head box. The rod includes a first end located in the sleeve and a second end located outside the sleeve. The pulley is connected to the first end of the rod. The second section of the rope is wound on the pulley.

In another aspect, the operation unit includes a pulley set instead of a single pulley. The pulley set includes at last two lower pulleys connected to the first end of the rod and at least one upper pulley connected to the head box. The second section of the rope is wound on the lower and upper pulleys.

Other objectives, advantages and features of the present invention will be apparent from the following description referring to the attached drawings.

### BRIEF DESCRIPTION OF DRAWINGS

The present invention will be described via detailed illustration of two embodiments versus the prior art referring to the drawings wherein:

FIG. 1 is a perspective view of a conventional blind device;

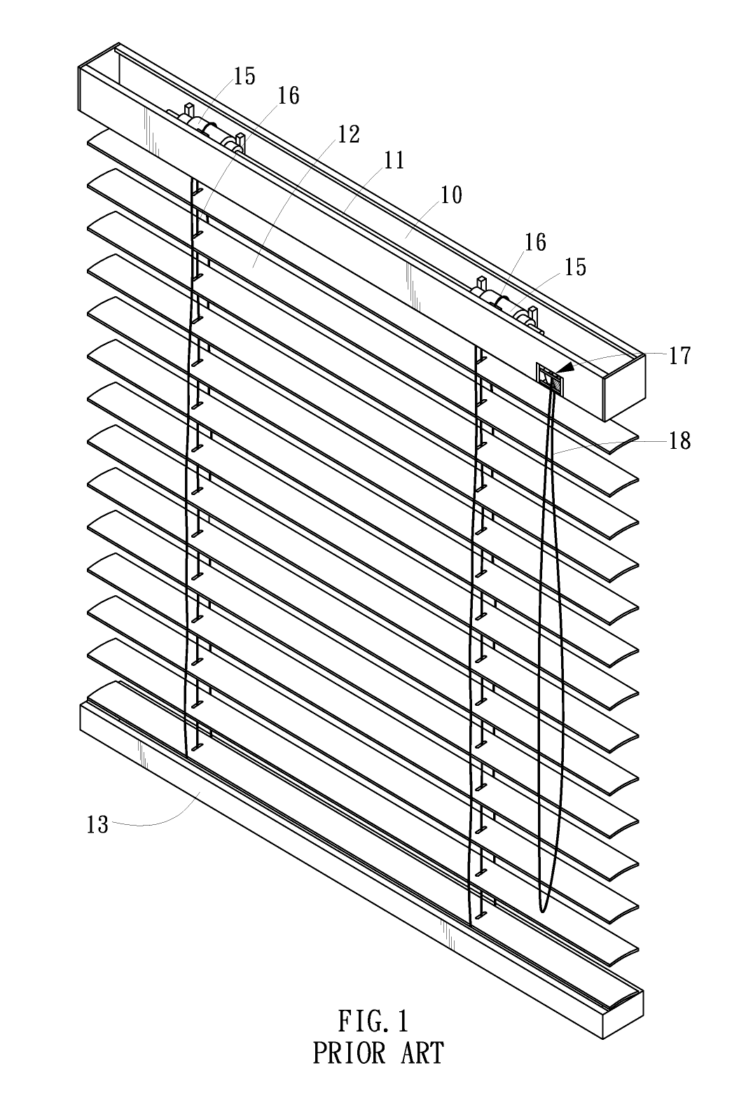

FIG. 2 is a perspective view of a blind device according to the first embodiment of the present invention;

FIG. 3 is a cross-sectional view of the blind device shown in FIG. 2;

FIG. 4 is another cross-sectional view of the blind device shown in FIG. 2;

FIG. 5 is a cross-sectional view of the blind device in another position than shown in FIG. 4; and

FIG. 6 is a cross-sectional view of a blind device according to the second embodiment of the present invention.

### DETAILED DESCRIPTION OF EMBODIMENTS

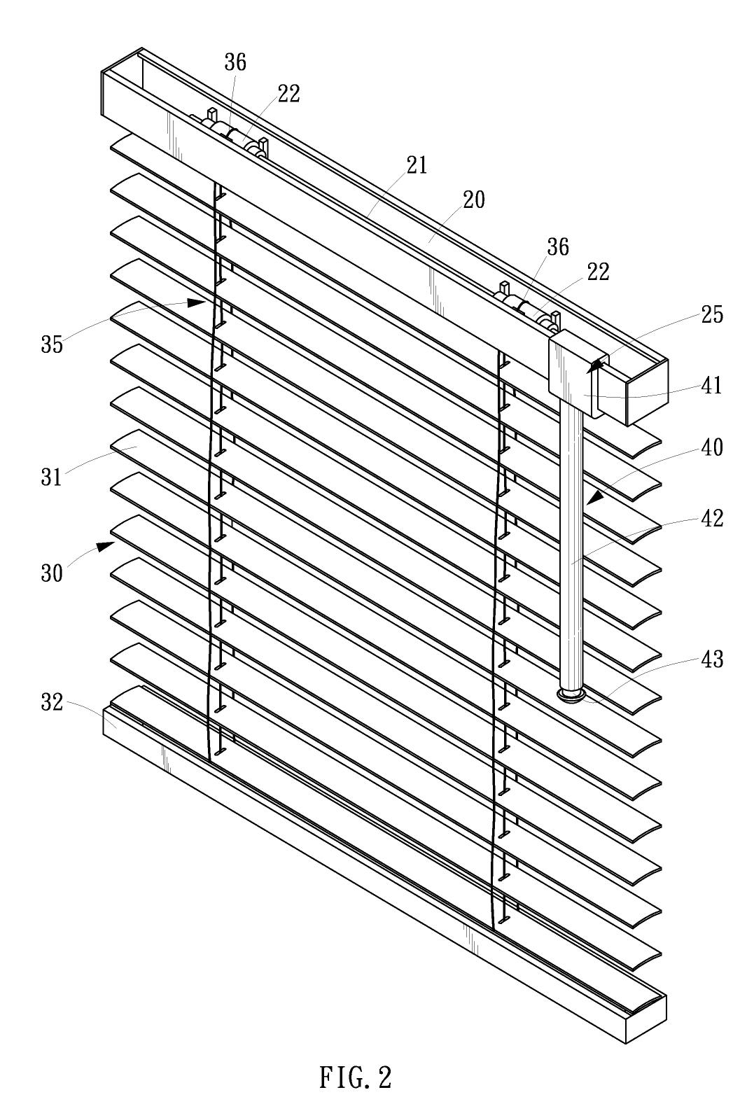

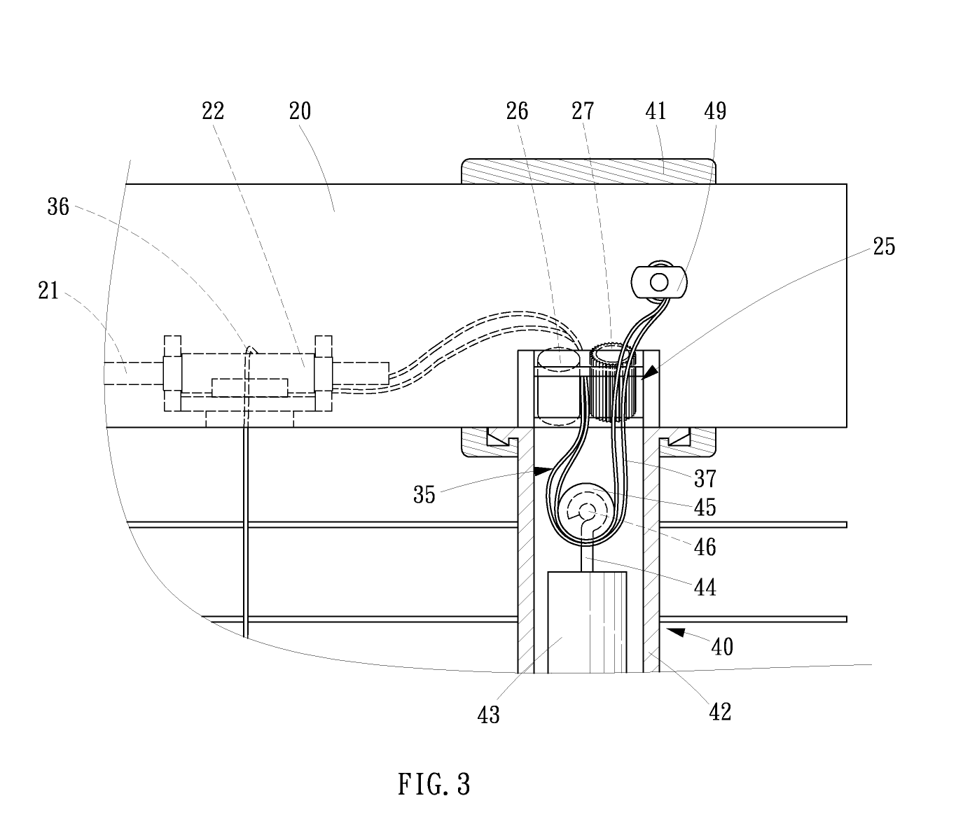

Referring to FIGS. 2 through 5, there is shown a blind device according to a first embodiment of the present invention. The blind device includes a head box 20, a blind 30 and an operation unit 40. The box 20 is attached to a frame of a window. The blind 30 is connected to the box 20. The operation unit 40 is operable to move the blind 30.

The head box 20 includes an axle 21 located therein, two rollers 22 supported on the axle 21, and a lift lock 25 located therein. The lift lock 25 includes a smooth wheel 26 supported on a pin securely located in the head box 20 and a toothed wheel 27 supported on another pin movably located in the head box 20.

The blind 30 may be a roman, pleated or venetian blind. The blind 30 is a venetian blind in the first embodiment. The blind 30 includes slats 31, a bottom rail 32 and a rope set 35. The slats 31 are connected to one another by two braided ladders. The braided ladders can be maneuvered to tilt the slats 31. The bottom rail 32 is located below the slats 31. The rope set 35 includes two ropes 36 in the first embodiment.

The operation unit 40 includes a connector 41, a sleeve 42, a rod 43, a hook 44, a pulley 45 and a fastener 49. The connector 41 is in the form of a hook for hooking the head box 20. The sleeve 42 is connected to the connector 41. The rod 43 is inserted in the sleeve 42. The hook 44 is secured to a first end of the rod 43 that is located in the sleeve 42. A second end of the rod 43 is located outside the sleeve 42. The pulley 45 includes a waist 46 extending between two disc-like ends thereof. The waist 46 is hooked by the hook 44.

In assembly, the ropes 36 are inserted through the lift lock 25. Each of the ropes 36 includes a first section located on a side of the lift lock 25 and a second section 37 located on another side of the lift lock 25. The length of the first section of each of the ropes 36 increases as the length of the second section 37 of each of the ropes 36 decreases. The first section of each of the ropes 36 is wound on a related one of the rollers 22, inserted through apertures defined in the slats 31, and tied to the bottom rail 32. The second section 37 of each of the ropes 36 is inserted in the sleeve 42, wound on the pulley 45, and tied to the head box 20 by the fastener 49.

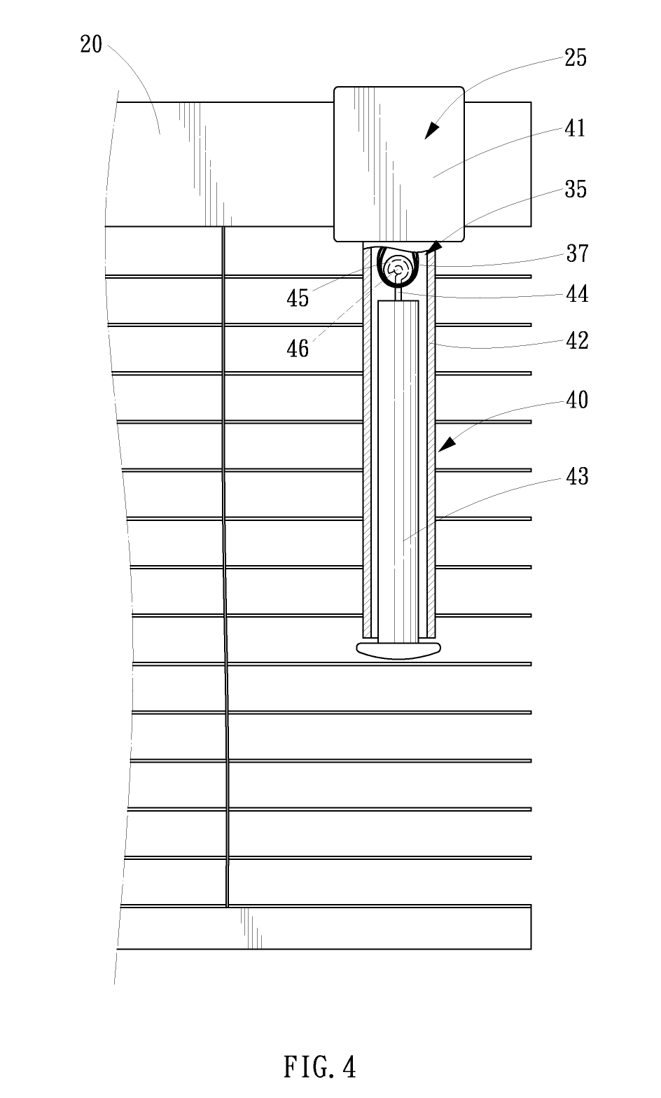

Referring to FIG. 4, the blind 30 is extended. That is, the slats 31 and the bottom rail 32 are lowered. Now, each of the ropes 36 is substantially located outside the sleeve 42. Thus, the pulley 45 and hence the rod 43 are lifted in the sleeve 42.

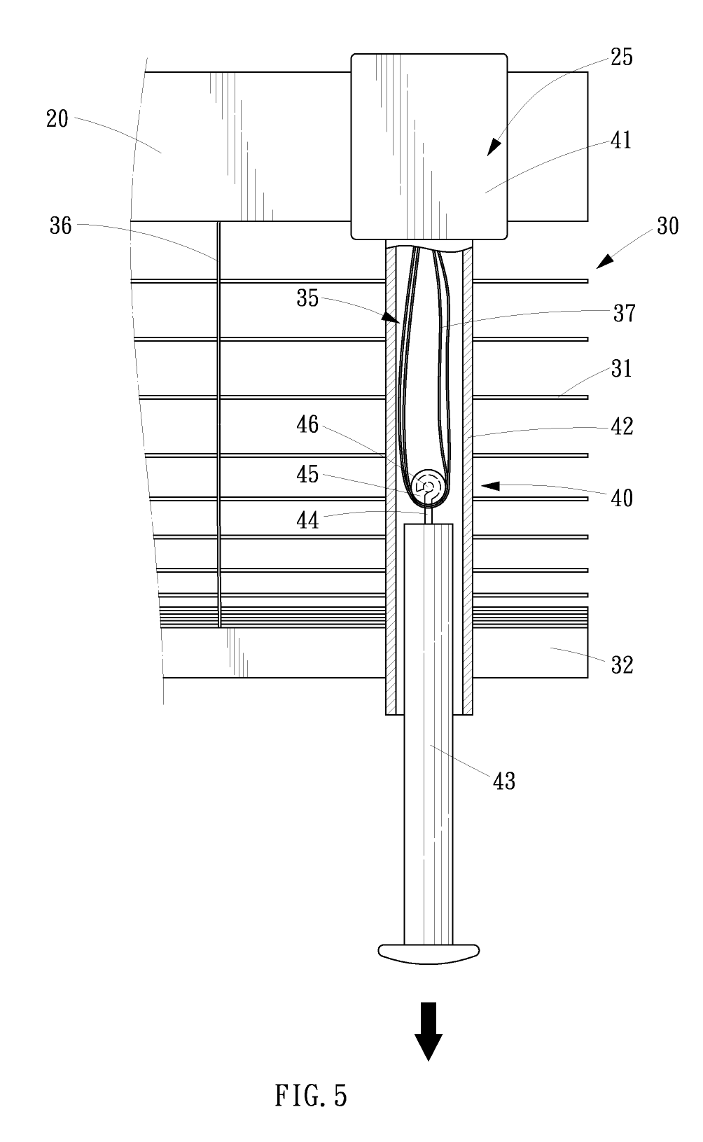

Referring to FIG. 5, the rod 43 and hence the pulley 45 are pulled down so that each of the ropes 36 is substantially located in the sleeve 42. Hence, the bottom rail 32 and hence the slats 31 are lifted.

The rod 43 and hence the second sections 37 of the ropes 36 can be biased to a direction relative to the lift lock 25 so that the former is locked by the latter. Thus, the bottom rail 32 and hence the slats 31 are kept in a lifted position, and the blind 30 is kept in a withdrawn position.

The rod 43 and hence the second sections 37 of the ropes 36 can be biased to an opposite direction relative to the lift lock 25 so that the former is released from the latter. Thus, the bottom rail 13 and hence the blind 12 are allowed to be lowered because of weight.

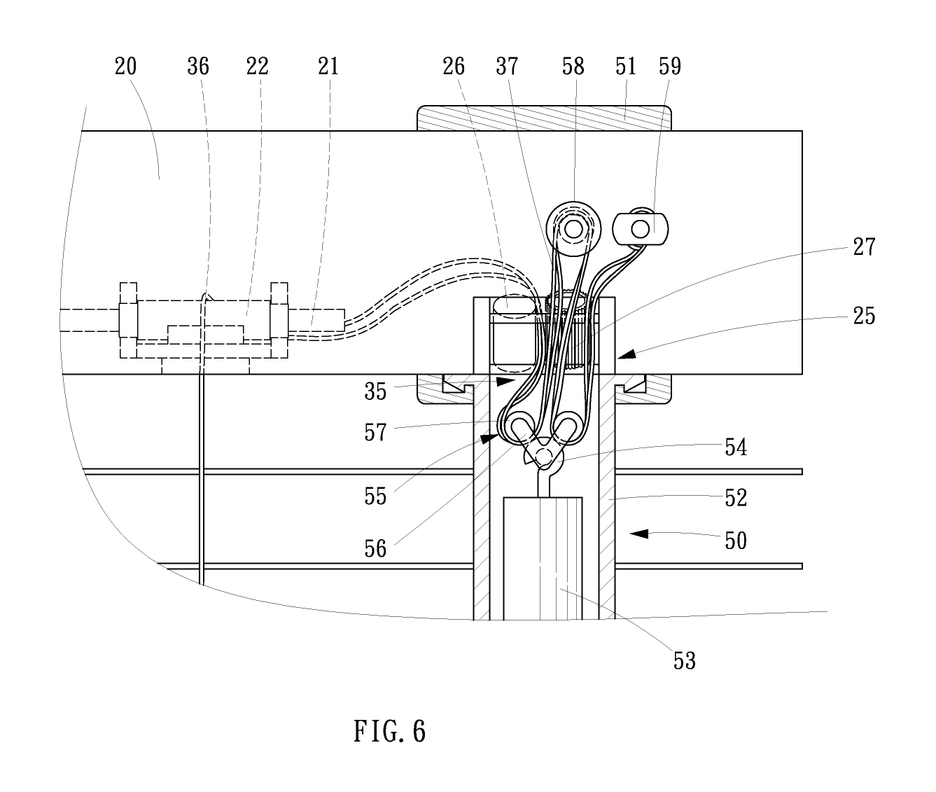

Referring to FIG. 6, there is shown a blind device according to a second embodiment of the present invention. The second embodiment is like the first embodiment except using an operation unit 50 instead of the operation unit 40. The operation unit 50 includes a connector 51 like the connector 41, a sleeve 52 like the sleeve 42, a rod 53 like the rod 43, a hook 54 like the hook 44, a pulley set 55 instead of the pulley 45, and a fastener 59 like the fastener 49. The pulley 55 includes two lower pulleys 57 and an upper pulley 58. The lower pulleys 57 are supported on a brace 56. The brace 56 includes three pins extending between two V-shaped elements. One of the lower pulleys 57 is supported on one of the pins and the other lower pulley 57 is supported on another one of the pins. The other pin is hooked by the hook 54. The upper pulley 58 is supported on a pin secured to the head box 20. The second section 37 of each of the ropes 36 is wound on the pulleys 57 and 58.

Advantageously, the second section 37 of each of the ropes 36 is located in the sleeve 42 or 52. That is, the second section 37 of each of the ropes 36 is kept away from kids. Kids could not play with and be strangled by the second section 37 of any of the ropes 36.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A blind device including:
a head box including an axle located therein, at least one roller supported on the axle, and a lift lock located therein;
a blind including a bottom rail and at least one rope inserted through the lift lock and formed with a first section wound on the roller and connected to the bottom rail on a side of the lift lock and a second section connected to the head box on another side of the lift lock; and
an operation unit including a sleeve connected to the head box, a rod including a first end located in the sleeve and a second end located outside the sleeve, and a pulley connected to the first end of the rod, wherein the second section of the rope is wound on the pulley.

2. The blind device according to claim 1, wherein the lift lock includes a smooth wheel rotationally located in the head box and a toothed wheel rotationally and movably located in the head box.

3. The blind device according to claim 1, wherein the blind is selected from the group consisting of a roman blind, a pleated blind and a venetian blind.

4. The blind device according to claim 1, wherein the head box includes two rollers located therein, wherein the blind includes two ropes, wherein the first section of each of the ropes is wound on a related one of the rollers.

5. The blind device according to claim 1, wherein the operation unit includes a hook secured to the first end of the rod, where the pulley is hooked by the hook.

6. The blind device according to claim 5, the pulley includes a waist hooked by the hook.

7. A blind device including:
a head box including an axle located therein, at least one roller supported on the axle, and a lift lock located therein;
a blind including a bottom rail and at least one rope inserted through the lift lock and formed with a first section wound on the roller and connected to the bottom rail on a side of the lift lock and a second section connected to the head box on another side of the lift lock; and
an operation unit including a sleeve connected to the head box, a rod including a first end located in the sleeve and a second end located outside the sleeve, and a pulley set including at last two lower pulleys connected to the first end of the rod and at least one upper pulley connected to the head box, wherein the second section of the rope is wound on the lower and upper pulleys.

8. The blind device according to claim 7, wherein the lift lock includes a smooth wheel rotationally located in the head box and a toothed wheel rotationally and movably located in the head box.

9. The blind device according to claim 7, wherein the blind is selected from the group consisting of a roman blind, a pleated blind and a venetian blind.

10. The blind device according to claim 7, wherein the head box includes two rollers located therein, wherein the blind includes two ropes, wherein the first section of each of the ropes is wound on a related one of the rollers.

11. The blind device according to claim 7, wherein the operation unit includes a hook secured to the first end of the rod, where the lower pulleys are hooked by the hook.

12. The blind device according to claim 7, the pulley set includes a brace connected to the first end of the rod, wherein the lower pulleys are supported on the brace.

13. The blind device according to claim 11, wherein the operation unit includes a hook connected to the first end of the rod, wherein the brace is hooked by the hook.
